(19) United States
(12) Patent Application Publication
(10) Pub. No.: US 2023/0266595 A1
(43) Pub. Date: Aug. 24, 2023

(54) OPTICAL SYSTEM FOR VIRTUAL IMAGE DISPLAY DEVICE, VIRTUAL IMAGE DISPLAY DEVICE, AND HEAD-MOUNTED DISPLAY

(71) Applicant: Yoshifumi SUDOH, Kanagawa (JP)

(72) Inventor: Yoshifumi SUDOH, Kanagawa (JP)

(21) Appl. No.: 18/107,512

(22) Filed: Feb. 9, 2023

(30) Foreign Application Priority Data
Feb. 21, 2022 (JP) 2022-024757

(51) Int. Cl. G02B 27/01; G02B 27/00; G02B 27/09; G02B 27/02

(52) U.S. Cl. CPC G02B 27/0172; G02B 27/0025; G02B 27/0983; G02B 27/027; G02B 2027/0178

(57) ABSTRACT

An optical system for a virtual image display device includes a light guide, a reflector, and an intermediate image forming portion. The light guide is configured to guide image light emitted from an image display element that displays an image, to proceed in the light guide. The light guide includes a partial reflector, a first portion on one side of the partial reflector, and a second portion on another side of the partial reflector. The partial reflector transmits the image light incident from the first portion and reflects the image light incident from the second portion to guide the image light to exit the light guide. The reflector reflects the image light transmitted through the partial reflector and the second portion back to the partial reflector. The intermediate image forming portion forms an intermediate image with the image light in the light guide.

### CROSS-REFERENCE TO RELATED APPLICATIONS

This patent application is based on and claims priority pursuant to 35 U.S.C. § 119(a) to Japanese Patent Application No. 2022-024757, filed on Feb. 21, 2022, in the Japan Patent Office, the entire disclosure of which is incorporated by reference herein.

### BACKGROUND

### Technical Field

The present disclosure relates to an optical system for a virtual image display device, a virtual image display device, and a head-mounted display.

### Related Art

Virtual image display devices have been developed for displaying an enlarged two-dimensional virtual image to an observer.

A virtual image display device is, for example, a glass device with an image display element embedded in its frame. The virtual image display device, for example, allows light (i.e., image light, or light containing image information) emitted from the image display element to proceed through a lens and emits the image light toward an observer, or a user. This allows the observer to observer an enlarged virtual image formed with the emitted image light.

In the virtual image display device, collimated light is caused to proceed through the lens serving as a light guide component. This configuration makes it difficult to reduce the thickness of the lens.

### SUMMARY

An embodiment of the present disclosure provides an optical system for a virtual image display device, the optical system including a light guide, a reflector, and an intermediate image forming portion. The light guide is configured to guide image light emitted from an image display element that displays an image, to proceed in the light guide. The light guide includes a partial reflector in the light guide, a first portion on one side of the partial reflector; and a second portion on another side of the partial reflector. The partial reflector is configured to transmit the image light incident from the first portion and reflect the image light incident from the second portion to guide the image light to exit the light guide. The reflector is configured to reflect the image light transmitted through the partial reflector and the second portion back to the partial reflector. The intermediate image forming portion is configured to form an intermediate image with the image light in the light guide.

Another embodiment of the present disclosure provides an optical system for a virtual image display device, the optical system including a light guide and an intermediate image forming portion. The light guide is configured to guide image light emitted from an image display element that displays an image, to proceed in the light guide. The light guide includes multiple partial reflectors in the light guide, a first portion on one side of the multiple partial reflectors, and a second portion on another side of the multiple partial reflectors. Each of the multiple partial reflectors is configured to transmit the image light incident from the first portion and reflect the image light incident from the second portion to guide the image light to exit the light guide. The intermediate image forming portion is configured to form an intermediate image with the image light in the light guide.

### BRIEF DESCRIPTION OF THE DRAWINGS

Amore complete appreciation of the disclosure and many of the attendant advantages thereof will be readily obtained as the same becomes better understood by reference to the following detailed description when considered in connection with the accompanying drawings, wherein:

FIG. 1 is an illustration of a head-mounted display incorporating a virtual display device according to an embodiment of the present disclosure;

FIG. 2 is a diagram of the configuration of a virtual image display device according to an embodiment of the present disclosure;

FIG. 3A, FIG. 3B, and FIG. 3C are ray diagrams for describing the reason why the thickness of a light guided can be reduced by forming, within the light guide, an intermediate image with image light from an image display element, according to an embodiment of the present disclosure;

FIG. 4 is a diagram of the optical configuration of a virtual image display device according to Numerical Example 1;

FIGS. 5A, 5B, and 5C are a spherical aberration diagram, an astigmatic aberration diagram, and a distortion aberration diagram of the virtual image display device according to Numerical Example 1;

FIGS. 6A, 6B, 6C, and 6D are lateral aberration diagrams of the virtual image display device according to Numerical Example 1;

FIG. 7 is a diagram of the optical configuration of a virtual image display device according to Numerical Example 2;

FIGS. 8A, 8B, and 8C are a spherical aberration diagram, an astigmatic aberration diagram, and a distortion aberration diagram of the virtual image display device according to Numerical Example 2;

FIGS. 9A, 9B, 9C, and 9D are lateral aberration diagrams of the virtual image display device according to Numerical Example 2:

FIG. 10 is a diagram of the optical configuration of a virtual image display device according to Numerical Example 3;

FIGS. 11A, 11B, and 11C are a spherical aberration diagram, an astigmatic aberration diagram, and a distortion aberration diagram of the virtual image display device according to Numerical Example 3;

FIGS. 12A, 12B, 12C, and 12D are lateral aberration diagrams of the virtual image display device according to Numerical Example 3:

FIG. 13 is a diagram of the optical configuration of a virtual image display device according to Numerical Example 4;

FIGS. 14A, 14B, and 14C are a spherical aberration diagram, an astigmatic aberration diagram, and a distortion aberration diagram of the virtual image display device according to Numerical Example 4;

FIGS. 15A, 15B, 15C, and 15D are lateral aberration diagrams of the virtual image display device according to Numerical Example 4:

FIG. 16 is a diagram of the optical configuration of a virtual image display device according to Numerical Example 5;

FIGS. 17A, 17B, and 17C are a spherical aberration diagram, an astigmatic aberration diagram, and a distortion aberration diagram of the virtual image display device according to Numerical Example 5;

FIGS. 18A, 18B, 18C, and 18D are lateral aberration diagrams of the virtual image display device according to Numerical Example 5; and

FIG. 19 is a diagram of the configuration of a virtual image display device according to a modification of an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure provide an optical system for a virtual image device, which allow a reduction in the thickness of a light guide that guides image light, a virtual image display device, and a head-mounted display incorporating the optical system.

Hereinafter, an optical system for a virtual image display device according to an embodiment, a virtual image display device, and a head-mounted display are described with reference to the drawings. In the following description, common or corresponding elements are denoted by the same or similar reference signs, and redundant description is appropriately simplified or omitted.

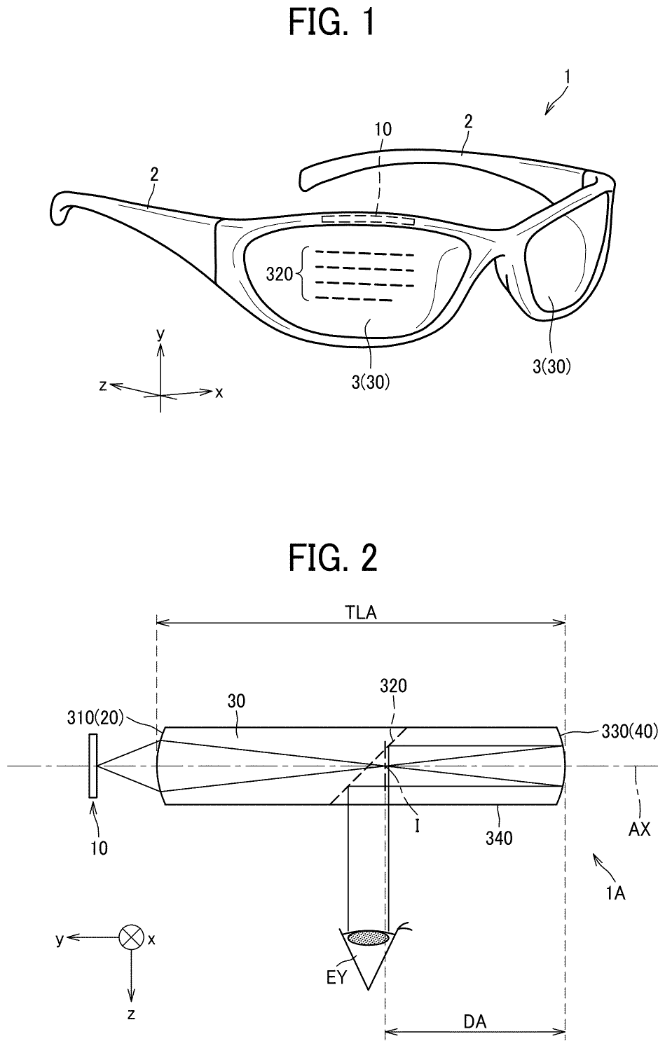

FIG. 1 is an illustration of a head-mounted display incorporating a virtual display device according to an embodiment of the present disclosure. In the present embodiment, a head-mounted display 1 is, for example, smart glasses that serve as a glasses-type wearable terminal. The smart glasses may be referred to as a glass device or a glass display.

Examples of the head-mounted display 1 includes virtual reality (VR) glasses, augmented reality (AR) Glasses, mixed reality (MR) Glasses, extended reality (XR) glasses, which are all wearable terminals.

In FIG. 1, the head-mounted display 1 is a binocular head-mounted display. In another embodiment, the head-mounted display 1 may be a monocular head-mounted display corresponding to one of the left and right eyes.

As illustrated in FIG. 1, the head mounted display 1 includes a frame portion 2 and a lens portion 3. The lens portion 3 is fitted into the frame portion 2. A pair of lens portions 3 is disposed corresponding to the left and right eyes of the wearer.

An image display element 10 for displaying an image is built in the frame portion 2. In FIG. 1, the image display element 10 is embedded in a portion of the frame portion 2 covering the upper edge of the lens portion 3. The installation position of the image display element 10 is not limited to the position illustrated in FIG. 1. Alternatively, the image display element 10 may be embedded in a portion of the frame portion 2 covering the lower edge of the lens portion 3.

The image display element 10 displays an image to be recognized as a virtual image. Examples of the image display element 10 include an organic light emitting diode (OLED) array, a laser diode (LD) array, a light emitting diode (LED) array, micro electromechanical systems (MEMS), and a digital micromirror device (DMD).

In the following description, a z-direction in FIG. 1 is referred to as a first horizontal direction from the lens portion 3 to the eyes of the wearer (a user), an x-direction in FIG. 1 is referred to as a second horizontal direction orthogonal to the z-direction, and a y-direction in FIG. 1 is referred to as a vertical direction orthogonal to each of the x-direction and the z-direction. The x-direction, the y-direction, and the z-direction orthogonal to each other form a left-handed system.

The term “direction” is used for convenience to describe the relative position between the components and does not indicate an absolute direction. Depending on the posture of the user wearing the head-mounted display 1, for example, the z-direction may not be the horizontal direction and may be the vertical direction.

Light rays (i.e., image light) emitted from the respective pixels of the image display element 10 are emitted from the image display element 10 in the −y-direction to enter the lens portions 3 and proceed through the lens portions 3. Thereafter, the light rays are emitted from the lens portions 3 in the +z-direction (i.e., to the eyes of the wearer) for display of a virtual image. In other words, the pair of lens portions 3 each forms an eye box in a region including the corresponding eye.

FIG. 2 is a diagram of the configuration of a virtual image display device 1A according to an embodiment of the present disclosure. The virtual image display device 1A is, for example, mounted on the head-mounted display 1.

The virtual image display device 1A according to the present embodiment may be mounted on a device other than the head-mounted display. As an example, the virtual image display device 1A is mounted on a head-up display.

The virtual image display device 1A includes an image display element 10 and an optical system for the virtual image display device including at least a light guide 30. In FIG. 2, the virtual image display device 1A includes the image display device 10 and a light guide 30 which is an example of an optical system for a virtual image display device. In FIG. 2, the left or right eye EY of the wearer is illustrated.

Although details will be described later, the optical system for the virtual image display device may further include an optical component other than the propagation optical system, the aperture stop a, and the light guide 30.

The light guide 30 is an optical component that guides image light from the image display element 10. In the virtual image display device 1A mounted on the head-mounted display 1, the lens portions 3 correspond to the light guide 30.

The light guide 30 has a first surface 310 (incident surface) on which the image light from the image display element 10 strikes. In the light guide 30, a partial reflector 320 is disposed to split the image light entered through the first surface 310 of the light guide 30, into reflected light and transmitted light.

The partial reflector 320 transmits a part (some rays) of image light guided to proceed in the −y-direction in the light guide 30 (i.e., image light guided to proceed in the light guide and incident on the partial reflector 320 from a first portion at one side of the partial reflector 320 and closer to the image display element 10 than a second portion on the other side of the partial reflector 320). The partial reflector 320 reflects a part (some rays) of image light guided to proceed in the +y-direction in the light guide 30 (i.e., image light guided to proceed in the light guide and incident on the partial reflector 320 from the second portion different from the first portion) and guides said some rays reflected off the partial reflector 320 to exit through the third surface 340 (the exit surface) of the light guide 30.

As indicated in Numerical Examples 1 to 5 to be described later, multiple partial reflectors 320 are arranged at an interval d between adjacent partial reflectors 320 along the optical axis AX within the light guide 30. In the present embodiment, the optical axis AX is defined as an optical path of light proceeding from the center of the effective pixel area of the image display element 10 in a direction perpendicular to the pixel array surface. The optical axis AX is also an optical axis of the virtual image display device 1A and is also an optical axis of each of optical components (for example, the light guide 30) included in the optical system for the virtual image display device 1A.

The image light is split into multiple light beams by the multiple partial reflectors 320, so that the eye box is enlarged, and the angle of view is also enlarged. This allows the wear to visually identify the virtual image easily and also a virtual image with a wide angle of view, irrespective of movement of the eye EY relative to the virtual image display device 1A.

The interval d satisfies, for example, conditional expression (1) below in order to obtain an eye box appropriate to achieve the intended performance.

0.5 mm<d<3.0 mm (1)

At the interval d of 0.5 mm or less, for example, non-uniformity in light amount (or non-uniformity in the luminance of a virtual image) more likely occurs due to image light reflected off a first partial reflector 320 and further reflected off a second partial reflector 320 adjacent to the first partial reflector 320. At the interval d of 3.0 mm or greater, the virtual image appears partially missing depending on a location within the eye box, which is caused by an excessively increased interval d.

The interval d may be equal or may not be qual between adjacent partial reflectors of the multiple partial reflectors 320.

The partial reflector 320 is oriented to allow the image light to form a predetermined angle (e.g., an angle of 45 degrees) relative to the optical axis AX (or the third surface 340 from which the image light is emitted in the +z-direction). The partial reflector 320 is, for example, a semi-reflective mirror. The partial reflector 320 may be a polarizing beam splitter (PBS).

The partial reflector 320 is composed of, for example, a partial reflection surface formed in a plane. Such a configuration with the partial reflector 320 formed in a plane (i.e., a planar partial reflector 320) increases ease of manufacture and facilitates aberration correction.

In an example in which the light guide 30 includes multiple partial reflectors 320 each having a non-flat surface (e.g., a surface having a curvature), the following issues are raised. In this structure, adjacent partial reflectors 320 are formed in different shapes to display a high-resolution virtual image with aberrations successfully corrected.

In order to correct aberrations successfully, the aberration correction is shared by each partial reflector 320 and an optical system (one or more optical components) between the image display element 10 and the partial reflector 320 along the optical path of the image light.

To achieve such a performance, each of the multiple partial reflectors 320 has a shape with a different free-form surface. This structure makes it difficult to obtain ease of manufacture and to correct aberrations.

In FIG. 2, the light guide 30 is composed of a pair of optical blocks (a first optical block and a second block). The first optical block has a partial reflection surface (i.e., a partial reflector 320) formed on its inclined surface. The inclined surface on which the partial reflection surface is formed in the first optical block is bonded to the inclined surface of the second optical block to form the light guide 30.

Each of the partial reflection surfaces is composed of a deposited film formed by depositing a metal material, for example. To increase the degree of adhesion between the optical blocks, a primer layer may be formed on the inclined surface of the optical block before forming the partial reflection surface on the primer layer.

Each optical block of the light guide 30 is a molding made of synthetic resin such as plastic. The light guide 30 made of such resin is lightweight. With a decrease in the weight of the light guide 30, the load on the nose of the wearer (the user) decreases. For this reason, the wearer can continue wearing the head-mounted display 1 for a long time without getting fatigued.

The virtual image display device 1A includes an intermediate image forming portion 20 that forms an intermediate image I formed with the image light from the image display element 10 in the light guide 30.

In FIG. 2, the first surface 310 of the light guide 30 is formed as a spherical surface or an aspherical surface and forms an intermediate image forming portion 20 that forms the intermediate image I of the image light from the image display element 10 in the light guide 30 (for example, in the vicinity of the partial reflector 320). The first surface 310 serving also as the intermediate image forming portion 20 enables a smaller virtual image display device 1A and lower manufacturing cost.

Alternatively, the virtual image display device 1A may include a propagation optical system in the optical path of the image light traveling from the image display element 10 to the light guide 30, to cause the image light from the image display element 10 to travel to the light guide 30 as in Numerical Example 1 to Numerical Example 5 below.

In this case, for example, the propagation optical system serves as the intermediate image forming portion 20. This configuration causes the propagation optical system to correct aberrations and thus allows successful correction of various aberrations.

As in Numerical Example 1 to Numerical Example 5, the virtual image display device 1A may include an aperture stop a between the propagation optical system (as the intermediate image forming portion 20) and the light guide 30 on the optical path of the image light. The aperture stop a allows only image light with its aberration corrected by the propagation optical system, out of the image light from the image display element 10 to enter the light guide 30.

From another point of view, unnecessary light whose aberration is not corrected by the propagation optical system can be cut by the aperture stop a. This reduces the occurrence of flare and enables a higher image quality.

Further, the aperture stop a with an appropriately set size allows a depth of field sufficient to achieve the intended performance and enables higher resolution. The shape of the aperture stop a may be circular or rectangular, and multiple aperture stops a may be arranged in a direction perpendicular to the optical axis AX.

Such multiple small apertures provide an eye box and allow a virtual image with a wide depth of field.

In addition, the aperture stop a between the propagation optical system and the light guide 30 allows the position at which light passed through the aperture stop a forms an image, which is caused by the optical system subsequent to the aperture stop a (i.e., the position corresponding to the exit pupil position of the optical system subsequent to the aperture stop a), to be in the vicinity of the eyes EY of the wearer. This enables visual identification of a virtual image in a wide angle of view range by the wearer.

The virtual image display device 1A includes a reflector 40. The reflector 40 is located at an end of the light guide 30 in a direction from the image display element 10 (i.e., opposite to the other end closer to the image display element 10 of the light guide 30 in FIG. 2) with the partial reflector 320 between the reflector 40 and the intermediate image forming portion 20 (i.e., between both ends of the light guide 30). In the virtual image display device 1A mounted on the head-mounted display 1, the reflector 40 is located at a lower frame portion below the lens portion 3, facing the image display element 10 in an upper frame portion above the lens portion 3.

The image light entered through the first surface 310 and transmitted through the partial reflector 320 is caused to proceed to the reflector 40. The reflector 40 includes a reflecting surface. The image light proceeding to the reflector 40 reflects off the reflecting surface of the reflector 40 and proceeds to the partial reflector 320 in the +−y direction.

The reflecting surface of the reflector 40 has positive power. The reflecting surface of the reflector 40 converts the image light reflected off the partial reflector 320 and incident upon the reflecting surface into collimated light or substantially collimated light and reflects the collimated light (or substantially collimated light) toward the partial reflector 320.

As a result, the collimated light or substantially collimated light proceeds through the light guide 30 in the +y-direction and reflects off the partial reflector 320 in the +z-direction, exiting from the third surface 340 of the light guide 30 to the eyes EY of the wearer. Thus, the light output from the light guide 30 reaches the eyes EY of the wearer. For the collimated light reflected off the reflecting surface of the reflector 40, the wearer can visually identify an infinite virtual image formed with the collimated light successfully.

For the substantially collimated light reflected off the reflecting surface of the reflector 40, the wearer can visually identify a virtual image with an appropriate virtual-image distance between the eyes EY and a plane onto which the virtual image is formed, successfully. The virtual-image distance may be changed as appropriate for the use of the virtual image display device 1A.

The light guide 30 includes a second surface 330 at the other side of the first surface 310 with the partial reflector 320 between the first surface 310 and the second surface 330. In FIG. 2, the second surface 330 is a reflecting surface serving as the reflector 40. The second surface 330 serving as the reflector 40 enables a smaller virtual image display device 1A and lower manufacturing cost.

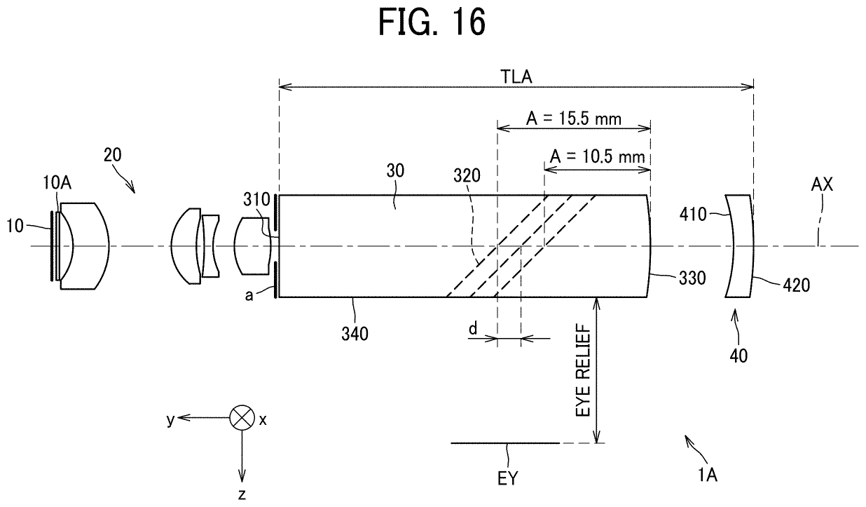

The virtual image display device 1A may include another optical component independent from the light guide 30 in the optical path of the image light subsequent to the light guide 30 as in Numerical Example 4 and Numerical Example 5 below (see FIGS. 13 and 16).

In this case (in FIGS. 13 and 16), for example, said another optical component constitutes the reflector 40 including the reflecting surface. The reflecting surface of the reflector 40 converts the image light transmitted through the partial reflector 320 and emitted from the second surface 330 into collimated light or substantially collimated light and reflects the collimated light or substantially collimated light toward the partial reflector 320.

As a result, the collimated light or substantially collimated light is caused by the second surface 330 to proceed in the light guide 30 in the +y-direction and reflects off the partial reflector 320 in the +z-direction, exiting from the third surface 340 of the light guide 30 to the eyes EY of the wearer. Thus, the light output from the light guide 30 reaches the eyes EY of the wearer.

As in Numerical Examples 4 and 5 (FIGS. 13 and 16) to be described later, an optical surface (i.e., a first surface 410 to be described later) having refractive power may be disposed between the reflecting surface and the second surface 330. In such a case, the image light entering the light guide 30 through the second surface 330 may be collimated or substantially collimated by optical surfaces, including the second surface 330, the optical surface (i.e., the first surface 410 to be described later), and the reflecting surface (i.e., a second surface 420 to be described later).

In other words, the image light may be converted into collimated light or substantially collimated light by the power of these optical surfaces at the time of entering the light guide 30 through the second surface 330.

This configuration causes the reflector 40 that is another optical component independent from the light guide 30 to correct aberrations and thus allows successful correction of various aberrations.

In such a configuration, the aberration correction is shared by the second surface 330, the reflecting surface (e.g., the second surface 420), and the optical surface (e.g., the first surface 410) between the second surface 330 and the reflecting surface. This allows more successful correction of aberrations.

In the virtual image display device 1A according to the present embodiment, the intermediate image forming portion 20 forms the intermediate image I with the image light emitted from the image display device 10 in the light guide 30. This reduces the thickness of the light guide 30 (in other words, reduce the size of the light guide 30 in the z-direction).

The light guide 30 made of such resin is lightweight. With a decrease in the weight of the light guide 30, the load on the nose of the wearer (the user) decreases. For this reason, the wearer can continue wearing the head-mounted display 1 for a long time without getting fatigued.

Further, forming an intermediate image I with the image light emitted from the image display element 10 in the light guide 30 allows the pupil of the optical system for the virtual image display device to be in the vicinity of the eyes EY of the wearer. This allows a wider eye box as well as a wider angle of view.

The present embodiment adopts the configuration in which the image light enters the light guide 30 through the first surface 310, passes through the partial reflector 320, and reflects off the reflector 40 to the partial reflector 320. Then, the image light reflects off the partial reflector 320 in the +z-direction and exits from the third surface 340 of the light guide 30. This is merely an example of a configuration in which the intermediate image I is formed in the light guide 30 to reduce the thickness of the light guide 30.

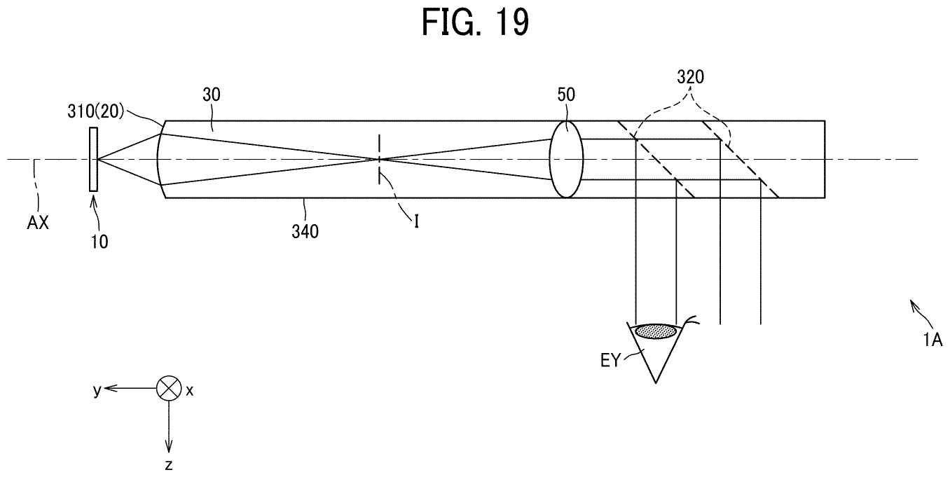

For example, FIG. 19 is a diagram of the configuration of a virtual image display device 1A according to a modification of an embodiment of the present disclosure.

As illustrated in FIG. 19, the intermediate image I is formed in the light guide 30 by the intermediate image forming portion 20, and the image light entered from the first surface 310 of the light guide 30 is converted into collimated light or substantially collimated light by a collimate optical system 50. Then, the collimated image light or substantially collimated image light reflects off the partial reflector 320 in the +z-direction and exit from the third surface 340 of the light guide 30.

The collimate optical system 50 may be a lens made of a material having a different refractive index (for example, a material having a high refractive index or a hollow structure) in the light guide 30 or may be a diffractive optical element formed in the light guide 30.

In other words, the use of the reflector 40 may be omitted in any configuration that allows a reduction in the thickness of the light guide 30 by forming the intermediate image I within the light guide 30. In such a configuration, multiple partial reflectors 320 are arranged to enlarge the eye box and increase the angle of view more.

In other words, the virtual image display device according to one embodiment of the present disclosure includes the intermediate image forming portion 20, the light guide 30, and multiple partial reflectors 320 without the use of the reflector 40. Such a configuration is also within the scope of the invention.

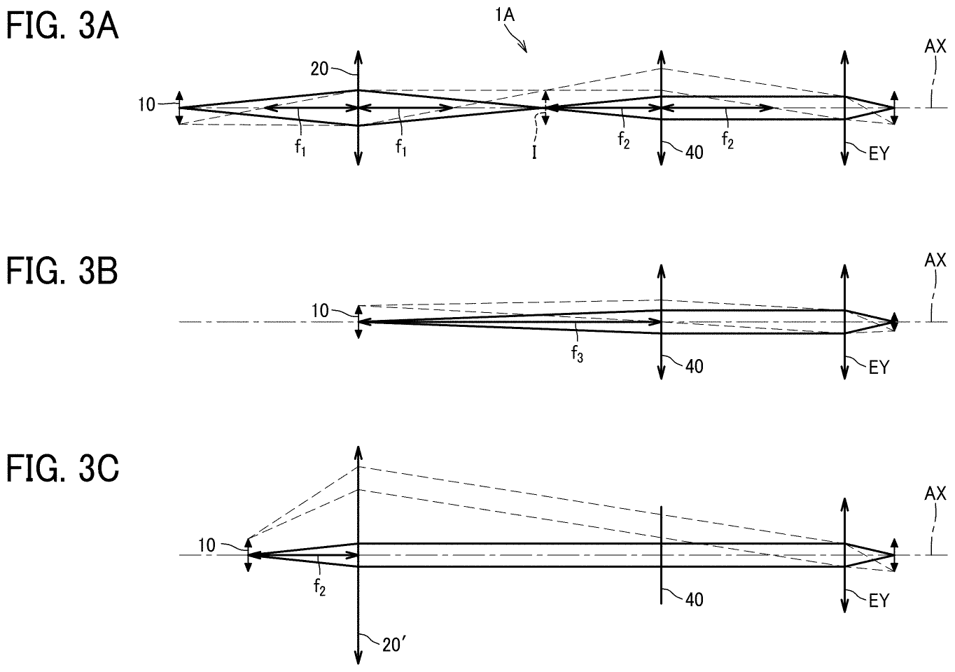

The following describes the reason why the light guide 30 can be made thinner by forming the intermediate image I with the image light emitted from the image display element 10 within the light guide 30 with reference to FIGS. 3A, 3B and 3C.

FIG. 3A is a ray diagram of the virtual image display device 1A according to an embodiment of the present disclosure, in which the intermediate image I has a magnification of 1×. In FIG. 3A, f₁ represents the focal distance of the intermediate image forming portion 20, and f₂ represents the focal distance of the reflector 40.

FIG. 3B is a ray diagram of a virtual image display device in which the use of the intermediate image forming portion 20 is omitted from the virtual image display device 1A according to an embodiment of the present disclosure. In FIG. 3B, f₁ indicates the focal distance of the reflector 40.

FIG. 3B is a ray diagram of a virtual image display device including a propagation optical system 20′ instead of the intermediate image forming portion 20 in the virtual image display device 1A according to an embodiment of the present disclosure. The propagation optical system 20′ converts the image light from the image display element 10 into collimated light and emits the collimated light toward the light guide 30.

In FIG. 3C, the reflector 40 is a reflecting surface (or plane) having no refractive power.

The angle of view in FIG. 3C is the same as that of FIG. 3A.

In FIGS. 3A to 3C, an axial light beam is indicated by a solid line, and an off-axis light beam is indicated by a broken line.

The size of the display image displayed by the image display element 10 is indicated by arrows at the position of the image display element 10. The size is the same between FIGS. 3A, 3B, and 3C.

In order to allow the wearer to see the scenery and the video of the external world, the distance between the reflector 40 (i.e., the reflecting surface) and the image display element 10 or the intermediate image forming portion 20 is provided sufficiently to achieve the intended performance.

In FIG. 3A, the distance between the intermediate image forming portion 20 and the reflector 40 corresponds to the width of the lens portion 3 in the vertical direction (i.e., the y-direction) in FIG. 1. This is because the width of the lens portion 3 in the vertical direction is to be set wide so that the wearer can see the scenery of the outside world.

Similarly, in FIG. 3B, the distance between the image display element 10 and the reflector 40, which corresponds to the width of the lens portion 3 in the vertical direction, is to set wide.

Similarly, in FIG. 3C, the distance between the propagation optical system 20′ and the reflector 40, which corresponds to the width of the lens portion 3 in the vertical direction, is to set wide.

In FIG. 3B in which the virtual-image distance between the eyes EY and a plane onto which the virtual image is formed is set to infinity, the focal distance f₃ is increased to cause the axial light beam and the off-axial light beam to proceed in the thin light guide 30.

More specifically, the focal distance f₃ in FIG. 3B is set so as to correspond to the distance between the image display device 10 and the reflector 40 described above. The image light is collimated by the reflector 40 to allow the wearer to visually identify the virtual image.

As described above, the focal distance f₃ is limited by the width of the lens portion 3. For this reason, it is impossible to shorten the focal distance f₃. The configuration in FIG. 3B fails to obtain a wider angle of view. In the configuration of FIG. 3B, in order to obtain the angle of view equivalent to that of FIG. 3A, the size of the image display element 10 is to be increased. This, however, increases the size of the virtual image display device itself.

In FIG. 3C in which the virtual-image distance between the eyes EY and a plane onto which the virtual image is formed is set to infinity, the thickness of the light guide 30 is increased in order to obtain the same angle of view as in FIG. 3A (i.e., so that the light guide 30 can also guide an off-axis light beam used for forming a wide angle of view).

More specifically, the propagation optical system 20′ in FIG. 3C is to be increased in a direction perpendicular to the optical axis AX (the up-to-down direction in the drawing) so as to allow the off-axial rays (indicated by the broken line in FIG. 3C) from the image display element 10 to proceed through the propagation optical system 20′. To further allow the image light emitted from the propagation optical system 20′ to proceed in the light guide 30, the thickness of the light guide 30 is increased up-to-down direction in FIG. 3C.

In the virtual image display device 1A according to an embodiment of the present disclosure in FIG. 3A, the intermediate image I is formed at a position closer to the reflector 40 (more specifically, the reflecting surface of the reflector 40) in the light guide 30 so that the focal length f₂ can be shortened. This enables a wider angle of view and a thinner light guide 30. In other words, the light guide 30 with its thickness reduced can also guide or allows an off-axis light beam to proceed therein for a wider angle of view.

A specific configuration of the virtual image display device 1A according to the present embodiment will be further described.

In order to configure the head-mounted display 1 mounted with the virtual image display device 1A in an appropriate size, the virtual image display device 1A may be configured to satisfy the following conditional expression (2):

0.5<β<2.0 (2)

where β is a magnification of the intermediate image I.

If the magnification β is 0.5 or less, the combined focal length of the optical elements subsequent to the position at which the intermediate image I is formed becomes too short. With too short combined focal length of the optical elements, the pupil of the optical system for the virtual image display device is formed at a position closer to the light guide 30 than to the eyes EY of the wearer. This makes it difficult to obtain a wider angle of view. If the magnification β is 2.0 or greater, the light guide 30 becomes difficult to be thin.

In order to obtain an appropriate virtual-image distance between the eyes EY and the plane onto which the virtual image is formed, the virtual image display device 1A may be configured to satisfy the following conditional expression (3),

−0.8<DA/R<−0.2 (3)

where DA is a distance along the optical axis AX between the intermediate image I and the reflecting surface of the reflector 40, and R is a paraxial curvature radius of the reflecting surface.

If the value DA/R is −0.8 or less, the power of the reflecting surface of the reflector 40 becomes too strong, and the virtual-image distance becomes farther than infinity. If the value DA/R is −0.2 or greater, the power of the reflective surface of the reflector 40 becomes too weak, and the virtual image distance becomes too short.

In Numerical Example 1 to Numerical Example 3 described later, the distance DA is the distance along the optical axis AX between the intermediate image I and the second surface 330 (as the reflecting surface) of the light guide 30. In Numerical Example 4 and Numerical Example 5 to be described later, the distance DA is the distance along the optical axis AX between the intermediate image I and the second surface 420 (as the reflecting surface) of the reflector 40 that is another optical component independent from the light guide 30.

In order to configure the head mounted display 1 mounted with the virtual image display device 1A in an appropriate size, the virtual image display device 1A may be configured to satisfy the following conditional expression (4):

15 mm<TLA<80 mm (4)

where TLA is the distance along the optical axis AX between the first surface 310 of the light guide 30 and the reflecting surface of the reflector 40.

If the distance TLA is 15 mm or less, the size of the light guide 30 along the optical axis AX becomes too small, and it becomes difficult to configure the head-mounted display 1 having an appropriate size that can be worn by the wearer. If the distance TLA is 80 mm or greater, the size of the light guide 30 along the optical axis AX becomes too large, and it becomes difficult to configure the head-mounted display 1 having an appropriate size that can be worn by the wearer.

In Numerical Example 1 to Numerical Example 3 described later, the distance TLA is the distance along the optical axis AX between the first surface 310 of the light guide 30 and the second surface 330 (as the reflecting surface) of the light guide 30. In Numerical Example 4 and Numerical Example 5 to be described later, the distance TLA is the distance along the optical axis AX between the first surface 310 of the light guide 30 and the second surface 420 (as the reflecting surface) of the reflector 40 that is another optical component independent from the light guide 30.

Next, specific Numerical Example 1 to Numerical Example 5 of the virtual image display device 1A will be described.

In Numerical Example 1 to Numerical Example 5, the size of the effective pixel region of the image display element 10 is as follows.

Numerical Example 1 and Numerical Example 2

A rectangular shape with a length of 2 mm in the z-direction, a length of 6 mm in the x-direction, and a length in the diagonal direction of 6.32 mm

Numerical Example 3

A rectangular shape with a length of 1.6 mm in the z-direction, a length of 6 mm in the x-direction, and a length in the diagonal direction of 6.21 mm

Numerical Example 4 and Numerical Example 5

A rectangular shape with a length of 3 mm in the z-direction, a length of 6 mm in the x-direction, and a length in the diagonal direction of 6.71 mm

In Numerical Examples 1 to 5, the virtual-image distance is infinity. The aberration diagrams in Numerical Example 1 to Numerical Example 5 are calculated in a case where an image is formed with an ideal lens having a focal distance of 17 mm.

Numerical Example 1

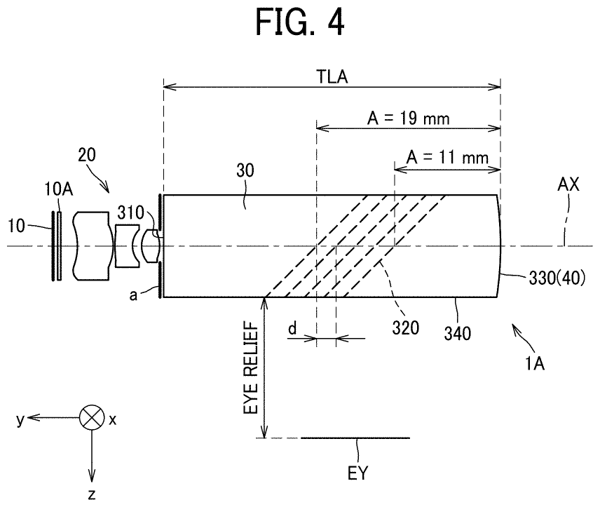

FIG. 4 is a diagram of the optical configuration of the virtual image display device 1A according to Numerical Example 1. As illustrated in FIG. 4, the virtual image display device 1A according to Numerical Example 1 includes the image display device 10, a propagation optical system as an example of the intermediate image forming portion 20, the aperture stop a, and the light guide 30, which are arranged in that order in a direction from the image display element 10. In Numerical Example 1, the intermediate image forming portion 20 includes three lenses that are rotationally symmetric about the optical axis AX. In Numerical Example 1, five partial reflectors 320 formed in a planar shape are arranged in the light guide 30.

In Numerical Example 1, the angles of view in the vertical direction (z-direction), the horizontal direction (x-direction), and the diagonal direction are 13.9 degrees, 40.0 degrees, and 42.9 degrees, respectively. The aperture stop a has a rectangular aperture with a length of 1.7 mm in the vertical direction (z-direction) and a length of 1.7 mm in the horizontal direction (x-direction).

Table 1 presents a specific numerical configuration of the virtual image display device 1A according to Numerical Example 1. In Table 1, R (mm) represents a radius of curvature (or a paraxial curvature radius) of each surface of the optical component, D (mm) represents the thickness of an optical component or the distance between the optical components along the optical axis AX, Nd represents a refractive index of the d-line (wavelength of 587. 562 nm), and vd represents an Abbe number of the d-line. The right column of the Abbe number in the Table 1 presents the product name and manufacturer of the material of the optical element.

The numbers in Table 1 are assigned to the respective surfaces of the image display element 10, the intermediate image forming portion 20, and the light guide 30 in order from the image display element 10. Herein, number 0 in Table 1 indicates an image display surface (i.e., pixel array surface) of the image display element 10. Numbers 1 and 2 in Table 1 indicate respective surfaces of the cover glass included in the image display element 10.

The cover glass is a glass plate that covers the image display surface of the image display element 10. In each optical configuration of Numerical Example 1 to Numerical Example 5, an element 10A is a cover glass.

Numbers 3 to 8 in Table 1 indicate the lens surfaces of the lenses forming the intermediate image forming portion 20. Number 9 in Table 1 indicates the aperture stop a.

Numbers 10 to 12 in Table 1 indicate the light guide 30 and the partial reflectors 320, respectively. More specifically, numbers 10, 11, and 12 in Table 1 indicate the first surface 310 of the light guide 30, the second surface 330 (reflecting surface) forming the reflector 40, and the partial reflector 320 (partial reflection surface), respectively.

The mark “A” in the column of the interval D for No. 11 in Table 1 indicates the distance between the second surface 330 and each partial reflector 320 (partial reflection surface) along the optical axis AX. For convenience, this distance will be referred to as distance A. The values of distance A to the five lenses are I1 mm, 13 mm, 15 mm, 17 mm, and 19 mm in order from the partial reflector 320 closest to the second surface 330 among the five partial reflectors 320. In other words, the five partial reflectors 320 are disposed at equal intervals of 2 mm. In FIG. 4, only the smallest distance A (i.e., 11 mm) and the largest distance A (i.e., 19 mm) are indicated.

Number 13 in Table 1 indicates the third surface 340 of the light guide 30. The interval D for the number 13 indicates a distance between the third surface 340 and the eye EY of the wearer, that is, an eye relief.

TABLE 1

| | R | D | Nd | υ d | | |
|---|---|---|---|---|---|---|
| 0 | | 0.00 | | | | |
| 1 | ∞ | 0.30 | 1.51633 | 64.14 | | S-BSL7(OHARA) |
| 2 | ∞ | 1.71 | | | | |
| 3* | −3.808 | 3.70 | 1.53100 | 56 | | E48R(ZEON) |
| 4* | −3.659 | 0.20 | | | | |
| 5* | 7.667 | 1.79 | 1.63200 | 23 | | OKP4HT(Osaka Gas Chemicals) |
| 6* | 1.700 | 1.01 | | | | |
| 7* | 2.743 | 1.81 | 1.53100 | 56 | | E48R(ZEON) |
| 8* | −3.181 | 0.44 | | | | |
| 9 | STOP | 0.00 | | | | |
| 10 | ∞ | 35.00 | 1.53100 | 56 | | E48R(ZEON) |
| 11* | −35.922 | A | 1.53100 | 56 | REFLECTION | E48R(ZEON) |
| 12 | ∞ | 5.00 | 1.53100 | 56 | REFLECTION | E48R(ZEON) |
| 13 | ∞ | 15.00 | | | | |

In Table 1, the surfaces marked with “*” represent aspherical surfaces. Table 2 is a list of data of each aspherical surface. In Table 2, the capital letter “E” represents a power in which 10 is the base and the number on the right of E is an exponent. The radius of curvature R of the aspherical surface is represented by a radius of curvature (paraxial curvature radius) along the optical axis AX. The aspherical shape is given by the following equation, where Z is a sag amount, C is a paraxial radius of curvature (1/R), h is a height from the optical axis (mm), K is a conic constant, and A4, A6.,. are aspherical coefficients of even orders equal to or higher than the fourth order.

Z=Ch²/{1+√(1−(1+k)c²h²)}+a⁴·h⁴+a⁶·h⁶+a⁸·h⁸+a¹⁰·h¹⁰

The same format as described above applies to the following Numerical Example 1 to Numerical Example 5.

TABLE 2

| | K | A4 | A6 | A8 | A10 |
|---|---|---|---|---|---|
| 3 | 0.000 | 1.41155E−02 | −7.60102E−04 | 1.45599E−04 | −5.75784E−06 |
| 4 | 0.000 | 2.19417E−02 | −5.45145E−03 | 1.14178E−03 | −7.99615E−05 |
| 5 | 0.000 | −1.07129E−02 | −4.74964E−03 | 2.81042E−03 | −4.20669E−04 |
| 6 | 0.000 | −7.45109E−02 | 1.22344E−02 | 2.03084E−03 | −2.88168E−03 |
| 7 | 0.000 | −6.33545E−03 | 4.17444E−03 | 1.40828E−03 | −5.36776E−04 |
| 8 | 0.000 | 1.29012E−02 | −4.76378E−04 | 4.95112E−03 | −1.59960E−03 |
| 11 | 0.000 | −1.74873E−06 | 9.50847E−08 | −6.04434E−10 | 7.29808E−13 |

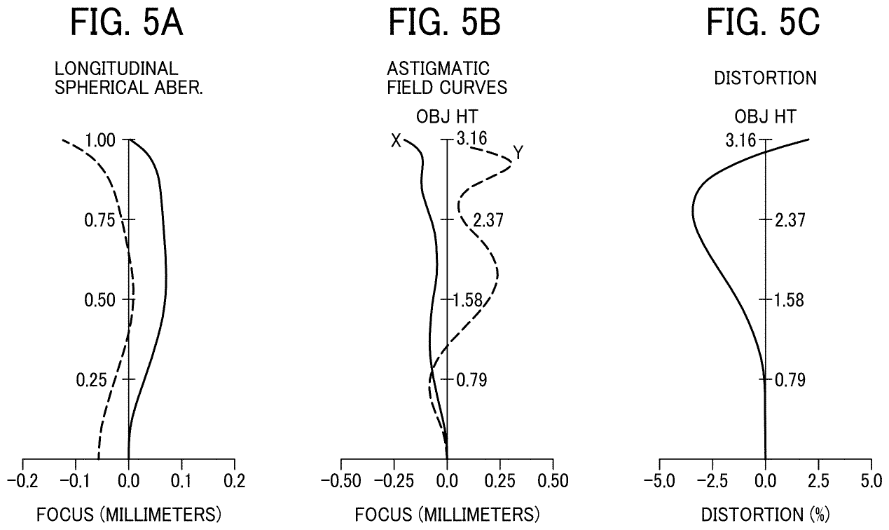

FIGS. 5A, 5B, and 5C are aberration diagrams of various aberrations (spherical aberrations, astigmatisms, and distortions) of the virtual image display device 1A according to Numerical Example 1.

The spherical aberration diagram in FIG. 5A presents spherical aberrations for the d-line and the g-line (435. 834 nm).

A solid line indicates spherical aberration for the d-line, and a broken line indicates spherical aberration for the g-line.

The astigmatic aberration diagram in FIG. 5B presents the astigmatic aberration for the d-line (i.e., the difference between the sagittal image plane and the meridional image plane). The solid line indicates aberration in the sagittal direction, and the broken line indicates aberration in the meridional direction. In the spherical aberration diagram and the astigmatism diagram, the vertical axis represents the image height, and the horizontal axis represents the amount of the aberration.

In the distortion diagram in 5C, the vertical axis represents the image height, and the horizontal axis represents the distortion rate at the d-line.

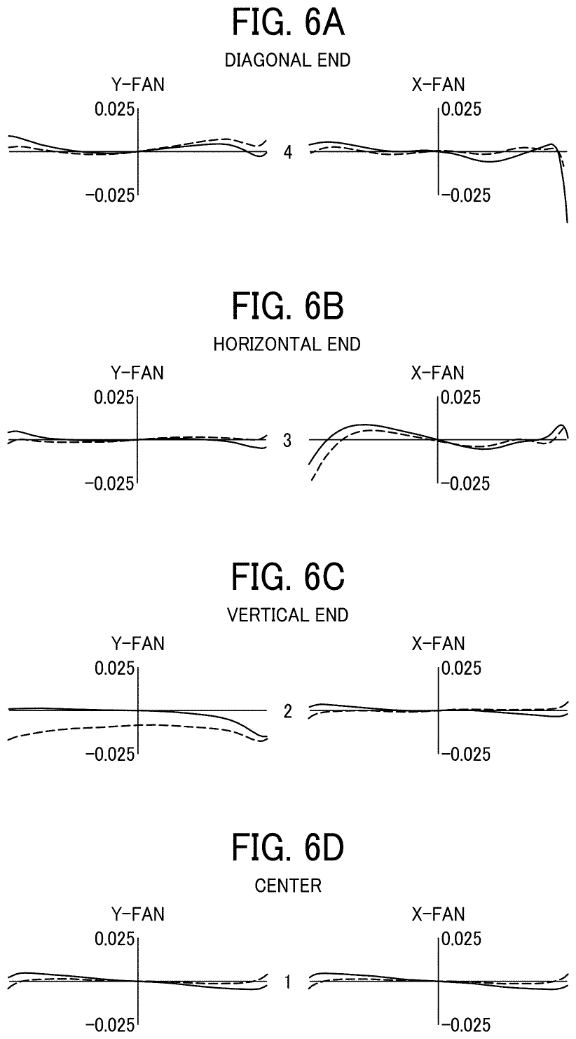

FIGS. 6A, 6B, 6C, and 6D are lateral aberration diagrams of the virtual image display device 1A according to Numerical Example 1.

FIG. 6A indicates lateral aberration diagrams for the d-line and the g-line at the diagonal end.

FIG. 6B indicates lateral aberration diagrams for the d-line and the g-line at the horizontal end.

FIG. 6C indicates lateral aberration diagrams for the d-line and the g-line at the vertical end.

FIG. 6D indicates lateral aberration diagrams for the d-line and the g-line at the center.

The solid line indicates the lateral aberration for the d-line, and the broken line indicates the lateral aberration for the g-line. The lateral aberration is measured in the x-direction and the y-direction.

The left diagram (“Y-FAN” noted at the top) of each of FIGS. 6A, 6B, 6C, and 6D indicates lateral aberration in the y-direction, and the right diagram (“X-FAN” noted at the top) of each of FIGS. 6A, 6B, 6C, and 6D indicates lateral aberration in the x-direction.

In Numerical Example 1, the intermediate image I is formed in the light guide 30, so that the light guide 30 can be thinned. Numerical Example 1 satisfies all of the above conditional expressions (1) to (4) as described below.
Interval d: 2.00 mm (see conditional expression (1))
Magnification β: 1.43 times (see conditional expression (2))
Value DA/R: −0.50 (see conditional expression (3))
Distance TLA: 35.00 mm (see conditional expression (4))

In the virtual image display device 1A according to Numerical Example 1, various aberrations are successfully corrected (see FIG. 5A, FIG. 5B, FIG. 5C, FIG. 6A, FIG. 6B, FIG. 6C, and FIG. 6D), a wide angle of view (for example, an angle of view exceeding 40 degrees in a diagonal direction) is obtained, and desired image quality is achieved. In addition, in the virtual image display device 1A according to Numerical Example 1, various effects are obtained by satisfying the above-described conditional expressions (1) to (4).

Numerical Example 2

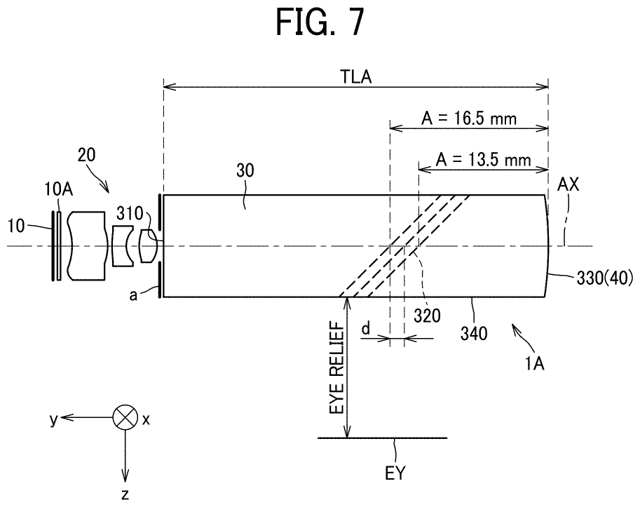

FIG. 7 is a diagram of the optical configuration of a virtual image display device 1A according to Numerical Example 2. As illustrated in FIG. 7, the optical configuration of the virtual image display device 1A according to Numerical Example 2 is the same as the optical configuration of the virtual image display device 1A according to Numerical Example 1 except that the virtual image display device 1A according to Numerical Example 2 has three partial reflectors 320 formed in a planar shape.

In Numerical Example 2, the angles of view in the vertical direction (z-direction), the horizontal direction (x-direction), and the diagonal direction are 13.8 degrees, 40.0 degrees, and 42.8 degrees, respectively. The aperture stop a has a rectangular aperture with a length of 1.8 mm in the vertical direction (z-direction) and a length of 1.8 mm in the horizontal direction (x-direction).

Table 3 presents a specific numerical configuration of the virtual image display device 1A according to Numerical Example 2. In Numerical Example 2, the values of distance A to the three lenses are 13.5 mm, 15 mm, 16.5 mm in order from the partial reflector 320 closest to the second surface 330 among the three partial reflectors 320. In other words, the three partial reflectors 320 are disposed at equal intervals of 1.5 mm. Table 4 lists data for each aspherical surface according to Numerical Example 2.

TABLE 3

| | R | D | Nd | υ d | | |
|---|---|---|---|---|---|---|
| 0 | | 0.00 | | | | |
| 1 | ∞ | 0.30 | 1.51633 | 64.14 | | S-BSL7(OHARA) |
| 2 | ∞ | 1.37 | | | | |
| 3* | −4.697 | 3.70 | 1.53100 | 56 | | E48R(ZEON) |
| 4* | −4.205 | 0.48 | | | | |
| 5* | 6.080 | 1.39 | 1.63200 | 23 | | OKP4HT(Osaka Gas Chemicals) |
| 6* | 1.807 | 1.34 | | | | |
| 7* | 4.145 | 1.86 | 1.53100 | 56 | | E48R(ZEON) |
| 8* | −2.873 | 0.72 | | | | |
| 9 | STOP | 0.00 | | | | |
| 10 | ∞ | 40.00 | 1.63200 | 23 | | OKP4HT(Osaka Gas Chemicals) |
| 11* | −40.889 | A | 1.63200 | 23 | REFLECTION | OKP4HT(Osaka Gas Chemicals) |
| 12 | ∞ | 5.00 | 1.63200 | 23 | REFLECTION | OKP4HT(Osaka Gas Chemicals) |
| 13 | ∞ | 15.00 | | | | |

TABLE 4

| | K | A4 | A6 | A8 | A10 |
|---|---|---|---|---|---|
| 3 | 0.000 | 9.62309E−03 | −1.03907E−03 | 2.07815E−04 | −9.01284E−06 |
| 4 | 0.000 | 2.24831E−02 | −5.32760E−03 | 1.14439E−03 | −8.58854E−05 |
| 5 | 0.000 | −7.37072E−03 | −3.99874E−03 | 2.22589E−03 | −3.93383E−04 |
| 6 | 0.000 | −5.45190E−02 | 7.31310E−03 | −5.30357E−05 | −1.29235E−03 |
| 7 | 0.000 | −3.06065E−03 | 8.02633E−04 | 7.92704E−04 | −3.13718E−04 |
| 8 | 0.000 | 6.79740E−03 | 2.48360E−04 | 5.71006E−04 | −2.06886E−04 |
| 11 | 0.000 | −4.70071E−07 | 9.12051E−08 | −8.00784E−10 | 2.07751E−12 |

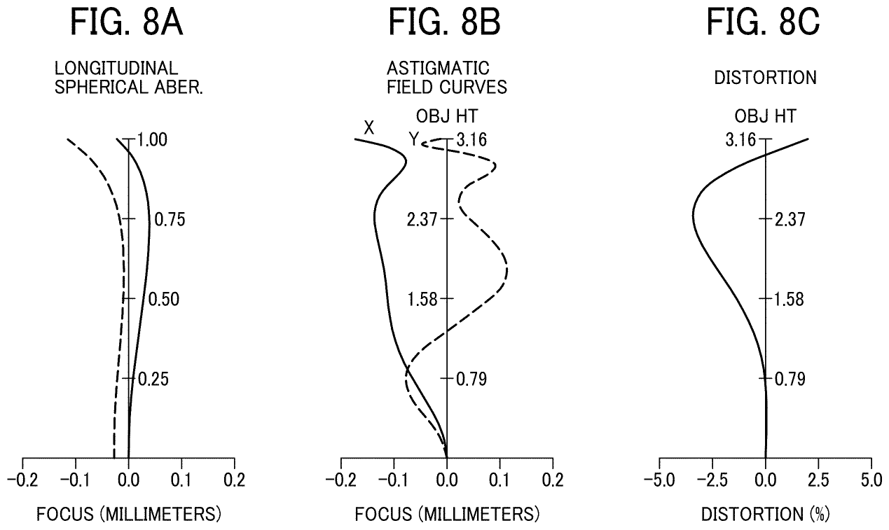

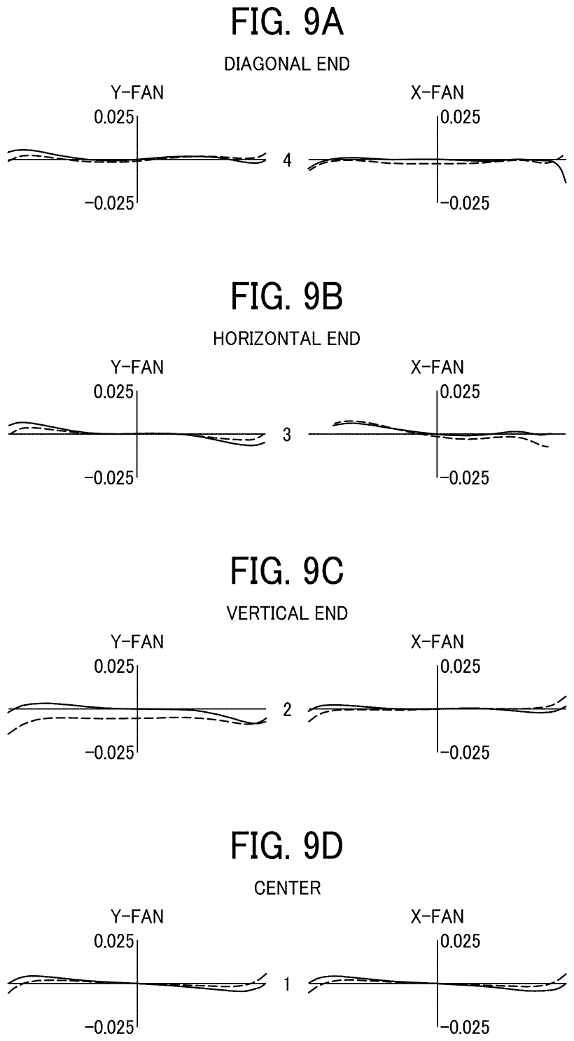

FIGS. 8A, 8B, and 8C are aberration diagrams of various aberrations (spherical aberrations, astigmatisms, and distortions) of the virtual image display device 1A according to Numerical Example 2. FIGS. 9A, 9B, 9C, and 9D are lateral aberration diagrams of the virtual image display device 1A according to Numerical Example 2.

In Numerical Example 2, the intermediate image I is formed in the light guide 30, so that the light guide 30 can be thinned.

Numerical Example 2 also satisfies all of the above conditional expressions (1) to (4) as described below.
Interval d: 1.50 mm (see conditional expression (1))
Magnification β−1.53 times (see conditional expression (2))
Value DA/R: −0.50 (see conditional expression (3))
Distance TLA: 40.00 mm (see conditional expression (4))

In the virtual image display device 1A according to Numerical Example 2, various aberrations are successfully corrected (see FIG. 8A, FIG. 8B, FIG. 8C, FIG. 9A, FIG. 9B, FIG. 9C, and FIG. 91D), a wide angle of view (for example, an angle of view exceeding 40 degrees in a diagonal direction) is obtained, and desired image quality is achieved. In addition, in the virtual image display device 1A according to Numerical Example 2, various effects are obtained by satisfying the above-described conditional expressions (1) to (4).

Numerical Example 3

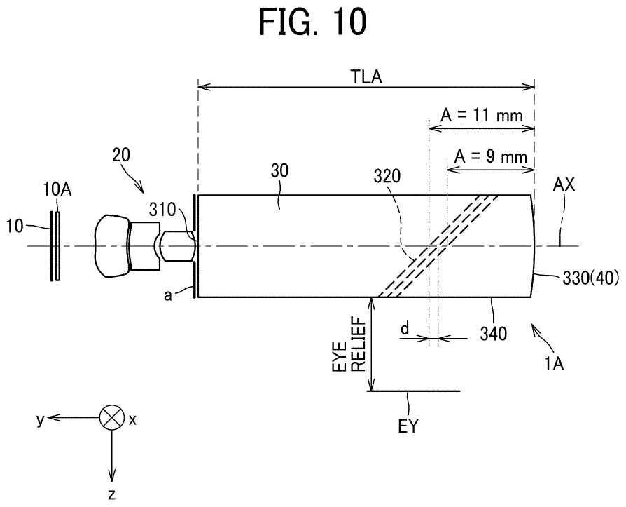

FIG. 10 is a diagram of the optical configuration of a virtual image display device 1A according to Numerical Example 3.

As illustrated in FIG. 10, the optical configuration of the virtual image display device 1A according to Numerical Example 3 is the same as the optical configuration of the virtual image display device 1A according to Numerical Example 2.

In Numerical Example 3, the angles of view in the vertical direction (z-direction), the horizontal direction (x-direction), and the diagonal direction are 11.2 degrees, 40.0 degrees, and 41.4 degrees, respectively. The aperture stop a has a rectangular aperture with a length of 1.6 mm in the vertical direction (z-direction) and a length of 1.6 mm in the horizontal direction (x-direction).

Table 5 presents a specific numerical configuration of the virtual image display device 1A according to Numerical Example 3. In Numerical Example 3, the values of distance A to the three lenses are 9 mm, 10 mm, 11 mm in order from the partial reflector 320 closest to the second surface 330 among the three partial reflectors 320. In other words, the three partial reflectors 320 are disposed at equal intervals of 1.0 mm. Table 6 lists data for each aspherical surface according to Numerical Example 3.

TABLE 5

| | R | D | Nd | υ d | | |
|---|---|---|---|---|---|---|
| 0 | | 0.00 | | | | |
| 1 | ∞ | 0.30 | 1.51633 | 64.14 | | S-BSL7(OHARA) |
| 2 | ∞ | 3.81 | | | | |
| 3* | −9.964 | 3.21 | 1.53100 | 56 | | E48R(ZEON) |
| 4* | 3.795 | 0.25 | | | | |
| 5* | 4.409 | 2.63 | 1.63200 | 23 | | OKP4HT(Osaka Gas Chemicals) |
| 6* | 1.803 | 0.54 | | | | |
| 7* | 2.640 | 3.70 | 1.53100 | 56 | | E48R(ZEON) |
| 8* | −2.802 | 0.30 | | | | |
| 9 | STOP | 0.00 | | | | |
| 10 | ∞ | 35.00 | 1.53100 | 56 | | E48R(ZEON) |
| 11* | −24.000 | A | 1.53100 | 56 | REFLECTION | E48FK(ZEON) |
| 12 | ∞ | 5.00 | 1.53100 | 56 | REFLECTION | E48R(ZEON) |
| 13 | ∞ | 10.00 | | | | |

TABLE 6

| | K | A4 | A6 | A8 | A10 |
|---|---|---|---|---|---|
| 3 | 0.000 | 2.89201E−02 | −1.90446E−03 | 7.91460E−05 | −9.04339E−07 |
| 4 | 0.000 | −2.59159E−02 | −2.18798E−03 | 1.23557E−03 | −1.07150E−04 |
| 5 | 0.000 | −1.80905E−02 | −5.18053E−03 | 1.97360E−03 | −1.72023E−04 |
| 6 | 0.000 | 1.62498E−02 | −1.42054E−02 | 1.15319E−02 | 4.59275E−04 |
| 7 | 0.000 | 9.91425E−03 | −7.08057E−03 | 8.14862E−03 | −1.60023E−03 |
| 8 | 0.000 | 4.21629E−03 | 3.61879E−03 | −5.30235E−03 | 3.72563E−03 |
| 11 | 0.000 | 1.36390E−04 | −1.56677E−06 | 9.96630E−09 | −2.21865E−11 |

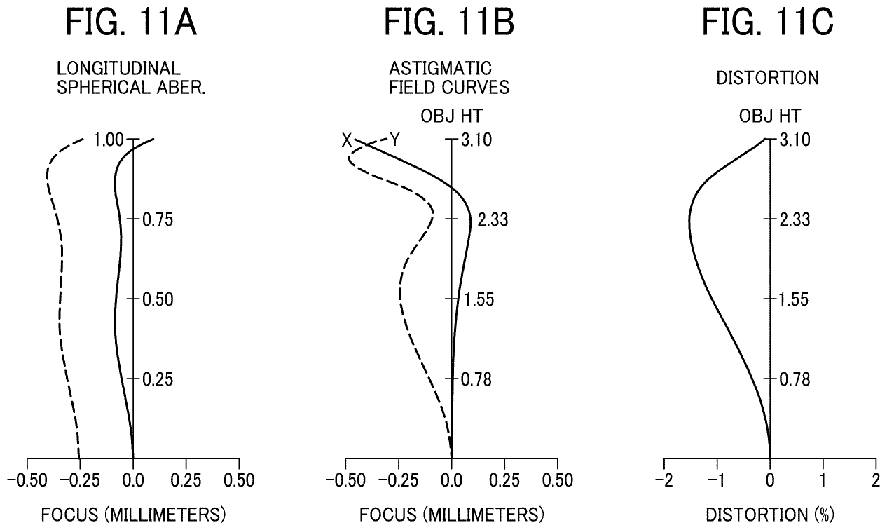

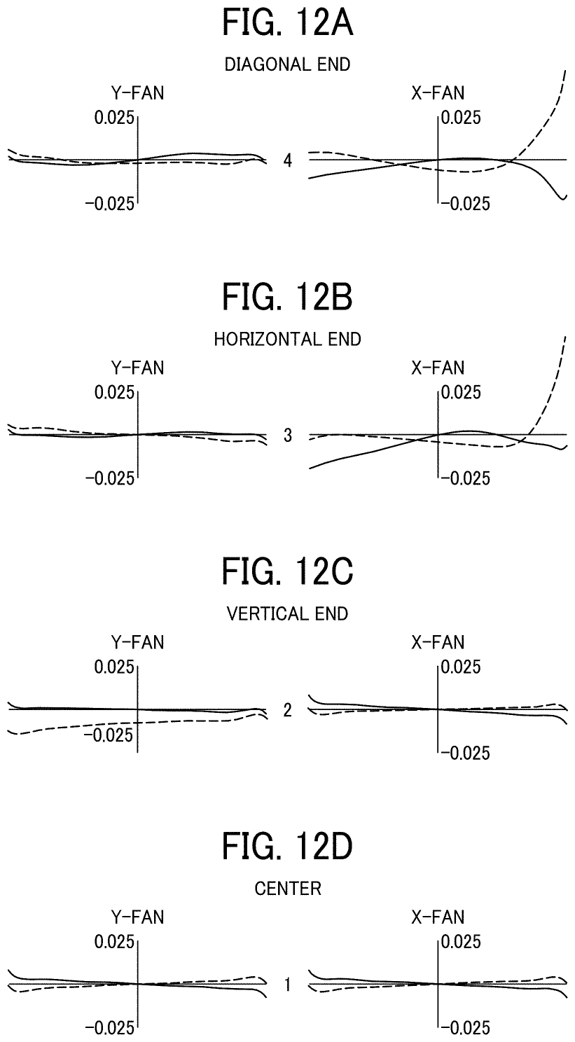

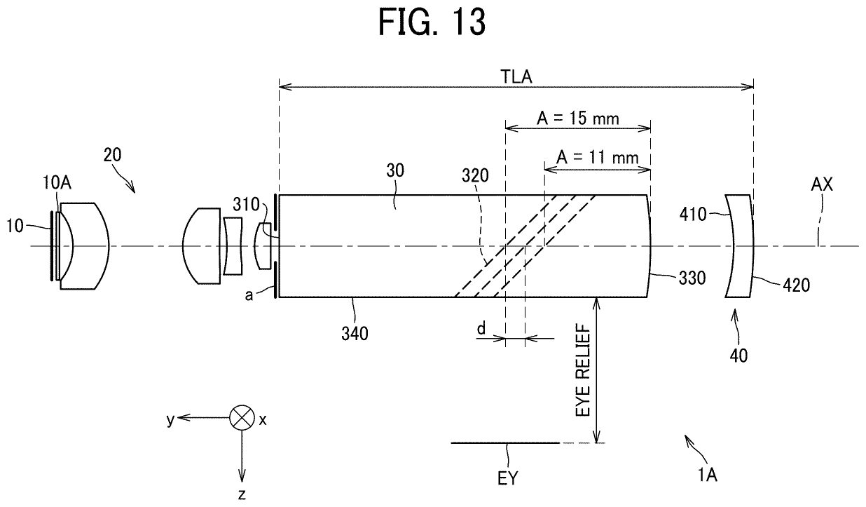

FIGS. 11A, 11B, and 11C are aberration diagrams of various aberrations (spherical aberrations, astigmatisms, and distortions) of the virtual image display device 1A according to Numerical Example 3. FIGS. 12A, 12B, 12C, and 12D are lateral aberration diagrams of the virtual image display device 1A according to Numerical Example 3.

In Numerical Example 3, the intermediate image I is formed in the light guide 30, so that the light guide 30 can be thinned. Numerical Example 3 also satisfies all of the above conditional expressions (1) to (4) as described below.
Interval d: 1.00 mm (see conditional expression (1))
Magnification β: 0.96 times (see conditional expression (2))
Value DA/R: −0.50 (see conditional expression (3))
Distance TLA: 35.00 mm (see conditional expression (4))

In the virtual image display device 1A according to Numerical Example 3, various aberrations are successfully corrected (see FIG. 11A. FIG. 11B, FIG. 11C, FIG. 12A, FIG. 12B, FIG. 12C, and FIG. 12D), a wide angle of view (for example, an angle of view exceeding 40 degrees in a diagonal direction) is obtained, and desired image quality is achieved. In addition, in the virtual image display device 1A according to Numerical Example 3, various effects are obtained by satisfying the above-described conditional expressions (1) to (4).

Numerical Example 4

FIG. 13 is a diagram of the optical configuration of a virtual image display device 1A according to Numerical Example 4.

As illustrated in FIG. 13, the optical configuration of the virtual image display device 1A according to Numerical Example 4 is the same as the optical configuration of the virtual image display device 1A according to Numerical Example 2 except that the intermediate image forming portion 20 includes four lenses that are rotationally symmetric about the optical axis AX, and also includes the reflector 40 that is an optical component independent from the light guide 30.

In Numerical Example 4, the angles of view in the vertical direction (z-direction), the horizontal direction (x-direction), and the diagonal direction are 14.8 degrees, 30.0 degrees, and 33.9 degrees, respectively. The aperture stop a has a rectangular aperture with a length of 2 mm in the vertical direction (z-direction) and a length of 3 mm in the horizontal direction (x-direction).

Table 7 presents a specific numerical configuration of the virtual image display device 1A according to Numerical Example 4. Supplementally, numbers 3 to 8 in Table indicate the lens surfaces of the lenses forming the intermediate image forming portion 20. Number 11 in the table indicates the aperture stop a. Table 8 lists data for each aspherical surface according to Numerical Example 4.

In Numerical Example 4, the image light transmitted through the partial reflector 320 and then emitted from the second surface 330 of the light guide 30 strikes on the first surface 410 of the reflector 40 and reflects off the second surface 420 (the reflecting surface) of the reflector 40. Thus, the image light is emitted from the first surface 410. As a result, the collimated light or substantially collimated light is caused by the second surface 330 to proceed in the light guide 30 in the +y-direction and reflects off the partial reflector 320 in the +z-direction, exiting from the third surface 340 of the light guide 30 to the eyes EY of the wearer. Thus, the light output from the light guide 30 reaches the eyes EY of the wearer.

As described above as an example, the image light emitted from the second surface 330 sequentially passes through the first surface 410, reflects off the second surface 420 (reflection surface), and passes through the first surface 410 of the reflector 40, striking on the second surface 330 while being converted into collimated light or substantially collimated light. The collimated light or substantially collimated light enters the light guide 30 through the second surface 330 and further strikes on the partial reflector 320.

Numbers 12 to 18 in Table 7 indicate the light guide 30 and the partial reflectors 320, and the reflector 40, respectively. More specifically, numbers 12, 13, 14, and 15 in Table 7 indicate the first surface 310 of the light guide 30, the second surface 330, the first surface 410, and the second surface 420 of the reflector 40, respectively. Number 16 in Table 7 indicates the first surface 410 in the optical path of light returned from or reflected off the second surface 420.

Number 17 in Table 7 indicates the second surface 330 of the light guide 30 in the optical path of light returned from the second surface 420. Number 18 in Table 7 indicates the partial reflector 320. In Numerical Example 4, the values of distance A to the three lenses are 11 mm, 13 mm, 15 mm in order from the partial reflector 320 closest to the second surface 330 among the three partial reflectors 320. In other words, the three partial reflectors 320 are disposed at equal intervals of 2 mm.

Number 19 in Table 7 indicates the third surface 340 of the light guide 30. The interval D for the number 19 indicates a distance between the third surface 340) and the eye EY of the wearer, that is, an eye relief.

TABLE 7

| | R | D | Nd | υ d | | |
|---|---|---|---|---|---|---|
| 0 | | 0.00 | | | | |
| 1 | ∞ | 0.30 | 1.51633 | 64.14 | | S-BSL7(OHARA) |
| 2 | ∞ | 1.35 | | | | |
| 3 | −5.419 | 3.70 | 1.53100 | 56 | | E48R(ZEON) |
| 4* | −9.255 | 7.56 | | | | |
| 5* | 5.139 | 3.70 | 1.53100 | 56 | | E48R(ZEON) |
| 6* | 38.390 | 0.78 | | | | |
| 7* | −9.697 | 1.42 | 1.63200 | 23.00 | | OKP4HT(Osaka Gas Chemicals) |
| 8* | 20.618 | 1.41 | | | | |
| 9* | 4.996 | 1.68 | 1.53100 | 56 | | E48R(ZEON) |
| 10* | −29.835 | 0.90 | | | | |
| 11 | STOP | 0.00 | | | | |
| 12 | ∞ | 38.00 | 1.53100 | 56 | | E48R(ZEON) |
| 13* | −19.599 | 8.50 | | | | |
| 14* | −16.375 | 2.00 | 1.53100 | 56 | | E48R(ZEON) |
| 15* | −36.980 | −2.00 | 1.53100 | 56 | REFLECTION | E48R(ZEON) |
| 16* | −16.375 | −8.50 | | | | |
| 17* | −19.599 | A | 1.53100 | 56 | | E48R(ZEON) |
| 18 | ∞ | 5.00 | 1.53100 | 56 | REFLECTION | E48R(ZEON) |
| 19 | ∞ | 15.00 | | | | |

TABLE 8

| | K | A4 | A6 | A8 | A10 |
|---|---|---|---|---|---|
| 4 | −1.085 | −2.09998E−03 | 1.20073E−04 | −4.14199E−06 | 3.20524E−08 |
| 5 | −0.677 | −5.26927E−04 | 1.70696E−05 | 3.25125E−07 | −1.65384E−08 |
| 6 | 0.000 | −1.73369E−03 | 1.23326E−04 | −4.02510E−06 | 3.09426E−08 |
| 7 | 0.000 | 9.80729E−04 | −4.07426E−06 | −2.19302E−07 | 2.01001E−08 |
| 8 | 0.000 | −4.55948E−04 | −2.43109E−05 | 2.10248E−06 | 2.04933E−08 |
| 9 | −0.842 | −1.63221E−03 | 2.94735E−05 | −1.88933E−06 | 2.22234E−08 |
| 10 | 0.000 | 1.28342E−03 | −1.16450E−06 | −1.07939E−05 | 1.23369E−06 |
| 15 | 0.000 | 7.93797E−06 | −1.10317E−07 | 7.23014E−10 | −1.75482E−12 |

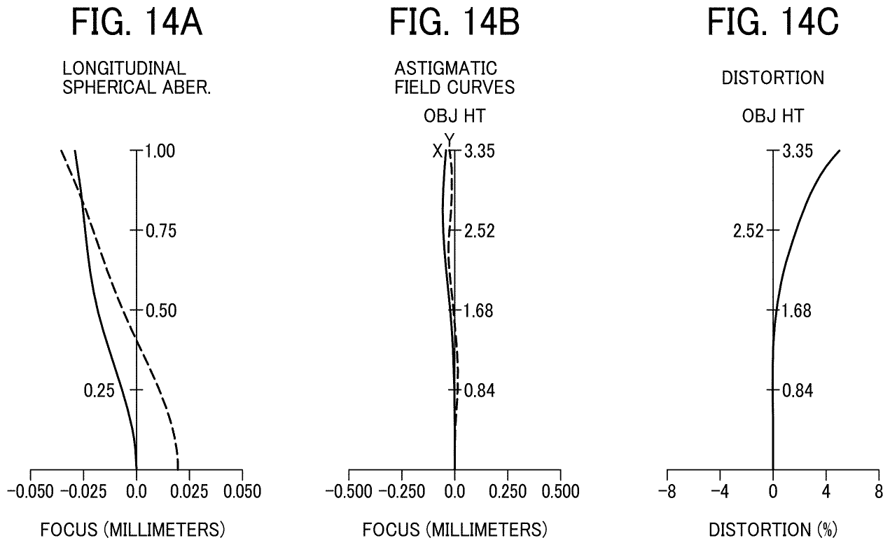

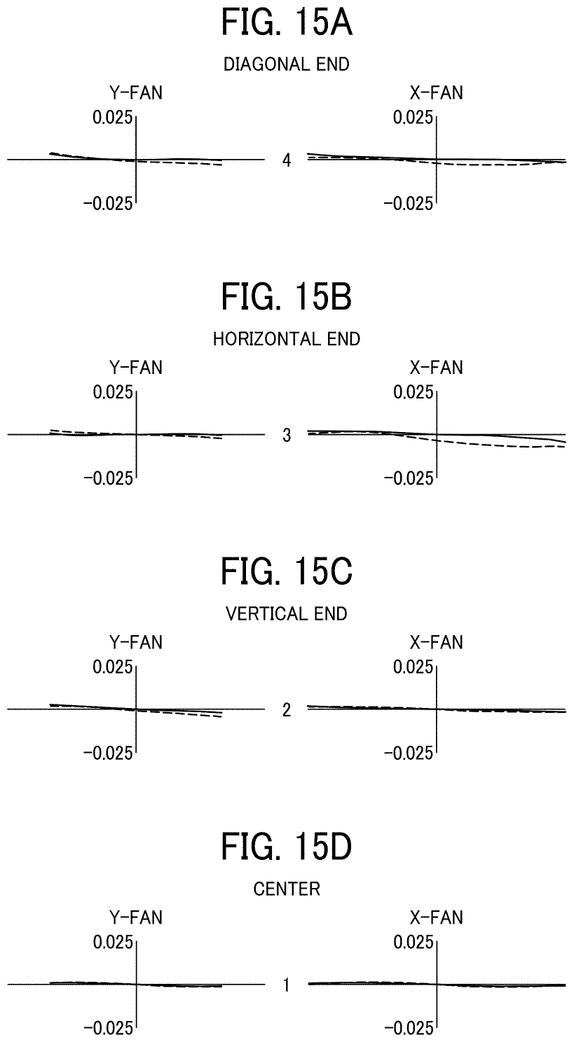

FIGS. 14A, 14B, and 14C are aberration diagrams of various aberrations (spherical aberrations, astigmatisms, and distortions) of the virtual image display device 1A according to Numerical Example 4. FIGS. 15A, 151B, 15C, and 15D are lateral aberration diagrams of the virtual image display device 1A according to Numerical Example 4.

In Numerical Example 4, the intermediate image I is formed in the light guide 30, so that the light guide 30 can be thinned. Numerical Example 4 also satisfies all of the above conditional expressions (1) to (4) as described below.
Interval d: 2.00 mm (see conditional expression (1))
Magnification β: 1.67 times (see conditional expression (2))
Value DA/R: −0.53 (see conditional expression (3))
Distance TLA: 48.50 mm (see conditional expression (4))

In the virtual image display device 1A according to Numerical Example 4, various aberrations are successfully corrected (see FIG. 14A, FIG. 14B, FIG. 14C. FIG. 15A, FIG. 15B, FIG. 15C, and FIG. 15D), a wide angle of view (for example, an angle of view exceeding 30 degrees in a diagonal direction) is obtained, and desired image quality is achieved. In addition, in the virtual image display device 1A according to Numerical Example 4, various effects are obtained by satisfying the above-described conditional expressions (1) to (4).

Numerical Example 5

FIG. 16 is a diagram of the optical configuration of a virtual image display device 1A according to Numerical Example 5.

As illustrated in FIG. 16, the optical configuration of the virtual image display device 1A according to Numerical Example 5 is the same as the optical configuration of the virtual image display device 1A according to Numerical Example 4.

In Numerical Example 5, the angles of view in the vertical direction (z-direction), the horizontal direction (x-direction), and the diagonal direction are 14.9 degrees, 30.0 degrees, and 33.6 degrees, respectively. The aperture stop a has a rectangular aperture with a length of 2 mm in the vertical direction (z-direction) and a length of 3 mm in the horizontal direction (x-direction).

Table 9 presents a specific numerical configuration of the virtual image display device 1A according to Numerical Example 5. In Numerical Example 5, the values of distance A to the three lenses are 10.5 mm, 13.0 mm, 15.5 mm in order from the partial reflector 320 closest to the second surface 330 among the three partial reflectors 320. In other words, the three partial reflectors 320 are disposed at equal intervals of 2.5 mm. Table 10 lists data for each aspherical surface according to Numerical Example 5.

TABLE 9

| | R | D | Nd | υ d | | |
|---|---|---|---|---|---|---|
| 0 | | 0.00 | | | | |
| 1 | ∞ | 0.30 | 1.51633 | 64.14 | | S-BSL7(OHARA) |
| 2 | ∞ | 1.40 | | | | |
| 3 | −5.487 | 3.42 | 1.53100 | 56 | | E48R(ZEON) |
| 4* | −9.492 | 6.21 | | | | |
| 5* | 3.743 | 2.52 | 1.53100 | 56 | | E48R(ZEON) |
| 6* | 11.884 | 0.69 | | | | |
| 7* | −22.852 | 0.90 | 1.63200 | 23.00 | | OKP4HT(Osaka Gas Chemicals) |
| 8* | 5.955 | 2.10 | | | | |
| 9* | 4.675 | 3.58 | 1.53100 | 56 | | E48R(ZEON) |
| 10* | −14.531 | 0.88 | | | | |
| 11 | STOP | 0.00 | | | | |
| 12 | ∞ | 38.00 | 1.53100 | 56 | | E48R(ZEON) |
| 13* | −17.295 | 8.50 | | | | |
| 14* | −20.957 | 2.00 | 1.53100 | 56 | | E48R(ZEON) |
| 15* | −50.000 | −2.00 | 1.53100 | 56 | REFLECTION | E48R(ZEON) |
| 16* | −20.957 | −8.50 | | | | |
| 17* | −17.295 | A | 1.53100 | 56 | | E48R(ZEON) |
| 18 | ∞ | 5.00 | 1.53100 | 56 | REFLECTION | E48R(ZEON) |
| 19 | ∞ | 15.00 | | | | |

TABLE 10

| | K | A4 | A6 | A8 | A10 |
|---|---|---|---|---|---|
| 4 | −8.370 | −2.16187E−03 | 1.00052E−04 | −5.43410E−06 | 1.42364E−07 |
| 5 | −0.854 | −9.43232E−04 | 1.17367E−05 | 3.27612E−07 | −1.52637E−10 |
| 6 | 0.000 | −1.73482E−03 | 1.26815E−04 | −3.59408E−06 | 3.50522E−08 |
| 7 | 0.000 | 1.15470E−04 | −6.58342E−06 | −7.37895E−07 | −3.64853E−09 |
| 8 | 0.000 | −6.93858E−04 | −1.62670E−05 | 3.11339E−06 | −6.63219E−08 |
| 9 | −0.682 | −1.40071E−03 | 7.61142E−05 | 4.78357E−07 | 4.73487E−07 |
| 10 | 0.000 | 1.31046E−03 | 3.72155E−05 | −1.29375E−06 | 1.98306E−06 |
| 15 | 0.000 | −3.70758E−06 | −9.87100E−09 | 6.98687E−10 | −3.64094E−12 |

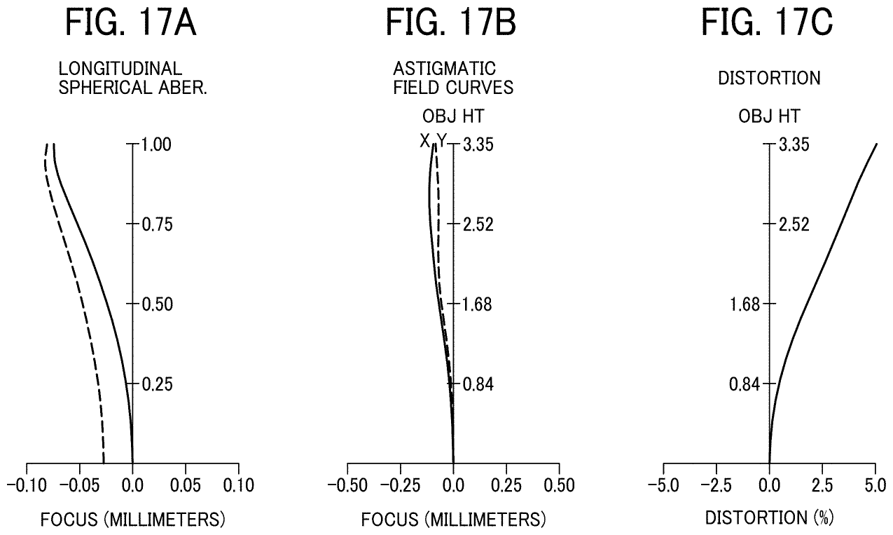

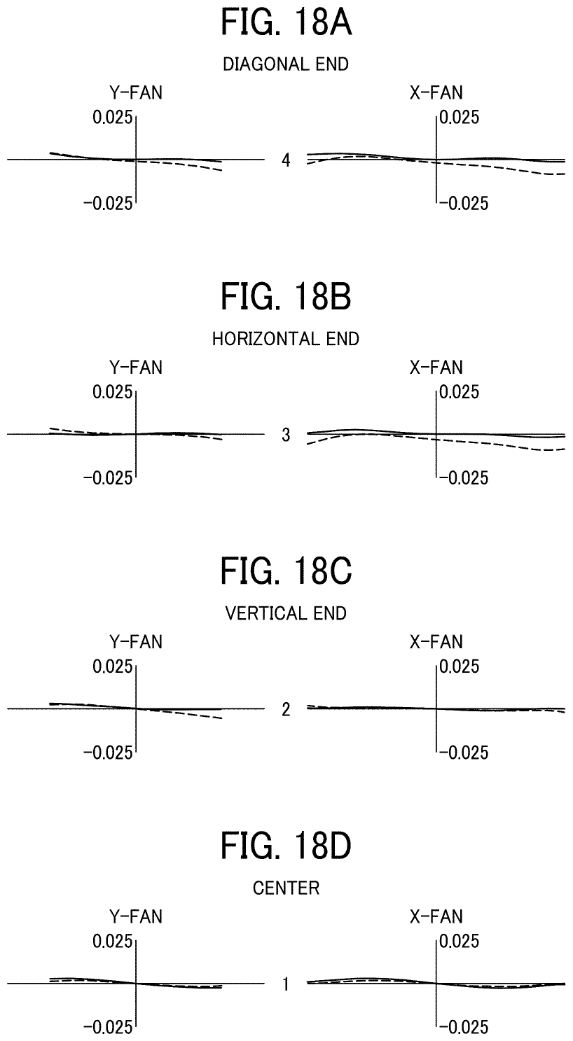

FIGS. 17A, 17B, and 17C are aberration diagrams of various aberrations (spherical aberrations, astigmatisms, and distortions) of the virtual image display device 1A according to Numerical Example 5. FIGS. 18A, 18B, 18C, and 18D are lateral aberration diagrams of the virtual image display device 1A according to Numerical Example 5.

In Numerical Example 5, the intermediate image I is formed in the light guide 30, so that the light guide 30 can be thinned. Numerical Example 5 also satisfies all of the above conditional expressions (1) to (4) as described below.
Interval d: 2.50 mm (see conditional expression (1))
Magnification β−1.67 times (see conditional expression (2))
Value DA/R: −0.40 (see conditional expression (3))
Distance TLA: 48.50 mm (see conditional expression (4))

In the virtual image display device 1A according to Numerical Example 5, various aberrations are successfully corrected (see FIG. 17A, FIG. 17B, FIG. 17C, FIG. 18A, FIG. 18B, FIG. 18C, and FIG. 18D), a wide angle of view (for example, an angle of view exceeding 30 degrees in a diagonal direction) is obtained, and desired image quality is achieved. In addition, in the virtual image display device 1A according to Numerical Example 5, various effects are obtained by satisfying the above-described conditional expressions (1) to (4).

The above is a description of exemplary embodiments of the present invention. The embodiments of the present invention are not limited to those described above, and various modifications are possible within the scope of the technical idea of the present invention. For example, the embodiments of the present application also include contents obtained by appropriately combining the embodiments explicitly described in the specification or the obvious embodiments.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An optical system for a virtual image display device, the optical system comprising:
a light guide configured to guide image light emitted from an image display element that displays an image, to proceed in the light guide, the light guide including:
a partial reflector in the light guide;
a first portion on one side of the partial reflector; and
a second portion on another side of the partial reflector,
the partial reflector configured to:
transmit the image light incident from the first portion; and
reflect the image light incident from the second portion to guide the image light to exit the light guide;
a reflector configured to reflect the image light transmitted through the partial reflector and the second portion back to the partial reflector; and
an intermediate image forming portion configured to form an intermediate image with the image light in the light guide.

2. The optical system according to claim 1,
wherein the partial reflector includes multiple partial reflectors.

3. The optical system according to claim 2,
wherein multiple partial reflectors are arranged at a prescribed interval along an optical axis of the optical system, the prescribed interval satisfies a conditional expression:
0.5 mm<d<3.0 mm
where d is the prescribed interval.

4. The optical system according to claim 1,
wherein the reflector includes a reflecting surface having positive power.

5. The optical system according to claim 4,
wherein the light guide includes:
the partial reflector;
a first surface at upstream end of the light guide in a direction from the first portion to the second portion, the first surface defining an incident surface through which the image light emitted from the image display element enters; and
a second surface at downstream end of the light guide in the direction, the second surface defining the reflecting surface of the reflector,
the partial reflector is between the first surface and the second surface.

6. The optical system according to claim 5,
wherein the first surface is an upstream end surface of the first portion in the direction,
the second surface is a downstream end surface of the second portion in the direction,
the intermediate image forming portion is at the first surface of the light guide,
the reflector is at the second surface of the light guide, and
the partial reflector is between the reflector and the intermediate image forming portion.

7. The optical system according to claim 4,
wherein the reflector is an optical component separate from the light guide, and
the reflecting surface is configured to:
receive the image light transmitted through the partial reflector and emitted from the light guide; and
reflect the image light struck on the reflector back to the partial reflector.

8. The optical system according to claim 4,
wherein the optical system satisfies a conditional expression:
−0.8<DA/R<−0.2
where
DA is a distance along an optical axis of the optical system between the intermediate image and the reflecting surface of the reflector, and
R is a paraxial curvature radius of the reflecting surface.

9. The optical system according to claim 1,
wherein the reflector includes a reflecting surface to reflect the image light transmitted through the partial reflector back to the partial reflector, and
the optical system satisfies a conditional expression:
15 mm<TLA<80 mm
where
TLA is a distance along an optical axis of the optical system between the reflecting surface of the reflector and an incident surface of the light guide through which the image light emitted from the image display element enters.

10. An optical system for a virtual image display device, the optical system comprising:
a light guide configured to guide image light emitted from an image display element that displays an image, to proceed in the light guide, the light guide including:
multiple partial reflectors in the light guide;
a first portion on one side of the multiple partial reflectors; and
a second portion on another side of the multiple partial reflectors,
each of the multiple partial reflectors configured to:
transmit the image light incident from the first portion; and
reflect the image light incident from the second portion to guide the image light to exit the light guide; and
an intermediate image forming portion configured to form an intermediate image with the image light in the light guide.

11. The optical system according to claim 10,
wherein multiple partial reflectors are arranged at a prescribed interval along an optical axis of the optical system, the prescribed interval satisfies a conditional expression:
0.5 mm<d<3.0 mm
where d is the prescribed interval.

12. The optical system according to claim 10,
wherein the partial reflector has a planar partial reflecting surface.

13. The optical system according to claim 1,
wherein the partial reflector has a planar partial reflecting surface.

14. The optical system according to claim 1,
wherein magnification of the intermediate image satisfies a conditional expression:
0.5<β<2.0
where β is the magnification of the intermediate image.

15. The optical system according to claim 1, further comprising a propagation optical system configured to guide the image light emitted from the image display element, to enter the light guide.

16. The optical system according to claim 15, further comprising an aperture stop between the propagation optical system and the light guide on an optical axis of the image light.

17. The optical system according to claim 16,
wherein the propagation optical system defines the intermediate image forming portion.

18. The optical system according to claim 1,
wherein the intermediate image forming portion is an incident surface of the light guide through which the image light emitted from the image display element enters.

19. A virtual image display device comprising:
the optical system according to claim 1; and
the image display element configured to emit image light to the optical system.

20. A head-mounted display comprising the virtual image display device according to claim 19.
